(19) United States
(12) Patent Application Publication
(10) Pub. No.: US 2014/0214464 A1
(43) Pub. Date: Jul. 31, 2014

(54) METHODS AND APPARATUS FOR MONITORING AND ANALYZING UTILITY CONSUMPTION

(71) Applicant: Quality Attributes Software, Inc., Phoenix, AZ (US)

(72) Inventors: Nico Willis, Phoenix, AZ (US); Bill Hoey, Bayville, NJ (US); Nasser Dassi, New Berlin, WI (US)

(21) Appl. No.: 14/228,013

(22) Filed: Mar. 27, 2014

Related U.S. Application Data
(63) Continuation-in-part of application No. 13/916,513, filed on Jun. 12, 2013.
(60) Provisional application No. 61/805,805, filed on Mar. 27, 2013.
(60) Provisional application No. 61/805,820, filed on Mar. 27, 2013.
(60) Provisional application No. 61/658,873, filed on Jun. 12, 2012.

(51) Int. Cl. G06Q 10/06

(52) U.S. Cl. CPC G06Q 10/0631
USPC 705/7.12

(57) ABSTRACT

Methods and apparatus for monitoring and analyzing utility consumption according to various aspects of the present technology generally comprise collecting and storing utility consumption information, processing utility consumption information, and outputting the processed utility consumption information. Utility consumption may be collected by one or more monitoring devices, and may comprise the use of one or more utilities and/or power sources, the use of energy sources used to power equipment, the generation of one or more utilities, energy, and/or power, a detected and/or measured environmental condition, and/or any other measurable quantity and/or detectable state relating to the environment the monitoring device is configured to operate in or observe. Processing and outputting utility consumption information may present utility consumption information in an easily-understandable and navigable manner.

### CROSS-REFERENCES TO RELATED APPLICATIONS

This application claims the benefit of U.S. Provisional Patent Application No. 61/805,805, filed Mar. 27, 2013, entitled METHODS AND APPARATUS FOR MONITORING UTILITY CONSUMPTION; claims the benefit of U.S. Provisional Patent Application No. 61/805,820, filed Mar. 27, 2013, entitled METHODS AND APPARATUS FOR ANALYZING UTILITY CONSUMPTION; is a continuation-in-part of U.S. patent application Ser. No. 13/916,513, filed on Jun. 12, 2013, entitled SYSTEM AND METHODS FOR REAL-TIME DETECTION, CORRECTION, AND TRANSFORMATION OF TIME SERIES DATA; which claims the benefit of U.S. Provisional Patent Application No. 61/658,873, filed Jun. 12, 2012, entitled SYSTEM AND METHODS FOR REAL TIME HEURISTIC ERROR CORRECTION AND PROJECTION MODELING OF ENERGY TIME SERIES DATA; and incorporates the disclosure of each application by reference. To the extent that the present disclosure conflicts with any referenced application, however, the present disclosure is to be given priority.

### BACKGROUND OF THE INVENTION

Building energy management systems are intended to reduce the energy usage and costs associated with operating a facility. However, current building energy management systems are either overly decoupled from the building automation systems or are heavily dependent upon the deployment and configuration of building automation systems. Further, current building energy management systems do not provide an in-depth or robust analysis of historical and current energy and resource usage. These shortcomings cause the building energy management systems to operate in their individual data island, require greater upfront commissioning costs due to their broad deployment requirements, and impede effective ongoing systems diagnostics and maintenance scheduling. As a result, building energy management systems are difficult to deploy and/or are lacking in their ability to effectively reduce energy usage and costs.

### SUMMARY OF THE INVENTION

Methods and apparatus for monitoring and analyzing utility consumption according to various aspects of the present technology generally comprise collecting and storing utility consumption information, processing utility consumption information, and outputting the processed utility consumption information. Utility consumption may be collected by one or more monitoring devices, and may comprise the use of one or more utilities and/or power sources, the use of energy sources used to power equipment, the generation of one or more utilities, energy, and/or power, a detected and/or measured environmental condition, and/or any other measurable quantity and/or detectable state relating to the environment the monitoring device is configured to operate in or observe. Processing and outputting utility consumption information may present utility consumption information in an easily-understandable and navigable manner.

Methods and apparatus according to various aspects of the present technology may help increase energy efficiency and reduce energy costs, may increase efficiency in initial commissioning, ongoing diagnostics, and everyday operations, may provide a broader set of historical usage data and more comprehensive data models which greatly enhance facility situational awareness based on relevant environmental factors, and may allow comprehensive analysis of energy and resource usage information for all facility types. Methods and apparatus according to various aspects of the present technology may improve near-real-time access to and visualization of energy usage across an entire organization, which will allow facilities managers to proactively save energy and reduce energy costs.

### BRIEF DESCRIPTION OF THE DRAWINGS

A more complete understanding of the present invention may be derived by referring to the detailed description when considered in connection with the following illustrative figures. In the following figures, like reference numbers refer to similar elements and steps throughout the figures.

FIG. 1A representatively illustrates a utility monitoring system according to an exemplary embodiment of the present invention;

FIG. 1B is a block diagram of a computing device capable of operating an exemplary embodiment of the present invention;

FIG. 2 representatively illustrates a utility monitoring method according to an exemplary embodiment of the present invention;

FIG. 3 representatively illustrates a display of information according to an exemplary embodiment of the present invention;

FIGS. 4A-C representatively illustrate a display of information for various zones according to an exemplary embodiment of the present invention;

FIG. 5 representatively illustrates a display of information and weather according to an exemplary embodiment of the present invention; and

FIG. 6 representatively illustrates a display of information according to an exemplary embodiment of the present invention.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present technology may be described in terms of functional block components and various processing steps. Such functional blocks may be realized by any number of hardware or software components configured to perform the specified functions and achieve the various results. For example, the present technology may employ systems, technologies, devices, algorithms, designs, services, and the like, which may carry out a variety of functions. In addition, the present technology may be practiced in conjunction with any number of hardware and software applications and environments. For example, the present technology may be practiced in conjunction with any number of websites, software applications, utility monitoring and information systems, building management systems, power monitoring and information systems, mapping systems, environmental monitoring systems, weather information and forecasting systems, communication systems, user management systems, location detection systems, data storage systems, and computing devices such as servers, computer databases, personal computers, portable computing devices, smart phones, tablet computers, and the like, and the systems and methods described are merely exemplary applications for the invention.

Methods and apparatus for monitoring utility consumption according to various aspects of the present invention may operate in conjunction with any suitable computing process or device, input system or method, output system or method, telecommunication network, utility, utility monitoring system, and/or environmental monitoring system. For example, various representative implementations of the present invention may be applied to building and/or facility systems. In addition, various representative implementations of the present technology may be applied to any computing device or application configured to communicate via a telecommunication network. Certain representative implementations may comprise, for example, program code stored on any combination of computing devices, wherein the program code facilitates collecting, storing, processing, and outputting utility consumption information. Various representative algorithms may be implemented with any combination of data structures, objects, processes, routines, other programming elements, and computing components and/or devices.

The present technology may involve multiple programs, functions, computing devices (such as client computers and/or servers), and the like. While the exemplary embodiments are described in conjunction with conventional computing devices, the various elements and processes may be implemented in hardware, software, or any combination of hardware, software, and other systems. Further, the present technology may employ any number of conventional techniques for generating and/or presenting content, interfacing a computing device to a network, transmitting and/or receiving data, providing a user interface, retrieving historical information such as past weather and/or utility rate information, communicating information, interfacing with a user, detecting and/or analyzing input to a computing device, gathering data, collecting and managing user accounts and information, calculating statistics, and the like.

A computing device may comprise conventional components, such as a processor, a local memory such as RAM, long term memory such as a hard disk, a network adaptor, and any number of input and/or output devices such as a keyboard, mouse, monitor, touch screen, microphone, speaker, motion sensor, orientation sensor, light sensor, and the like. The various memories of the computing device may facilitate the storage of one or more computer instructions, such as a software routine and/or software program, which may be executable by the processor to perform the methods of the invention. A computing device may comprise a personal computer, server, mobile phone, smart phone, tablet computer, kiosk, portable computer, and the like. Further, the databases, systems, and/or components of the present technology may consist of any combination of databases, systems, and/or components at a single location or at multiple locations. Each database, system, and/or component of the present technology may comprise any suitable security features, such as firewalls, access codes, encryption, de-encryption, compression, decompression, and/or the like.

The present technology may be embodied as a method, a system, a device, and/or a computer program product. Accordingly, the present technology may take the form of an entirely software embodiment, an entirely hardware embodiment, or an embodiment combining aspects of both software and hardware. Furthermore, the present technology may take the form of a computer program product on a computer-readable storage medium having computer-readable program code embodied in the storage medium. Any suitable computer-readable storage medium may be utilized, including any combination of hard disks, CD-ROM, optical storage devices, magnetic storage devices, USB memory devices, any appropriate volatile or non-volatile memory system, and the like. The present technology may take the form of a downloadable and/or cloud-based non-downloadable computer program product and/or methods.

Software and/or software elements according to various aspects of the present technology may be implemented with any programming, scripting, or computer language or standard, such as, for example, AJAX, C, C++, Java, JavaScript, COBOL, assembly, PERL, eXtensible Markup Language (XML), PHP, CSS, etc., or any other programming and/or scripting language, whether now known or later developed. Software and/or software elements according to various aspects of the present technology may be implemented with any communications protocol, such as BACnet, WebRTC, flat files (CSV, XML), and the like. Further, the present technology may be used in conjunction with a computing device running any operating system such as any version of Windows, MacOS, OS/2, BeOS, Linux, UNIX, Android, iOS, or any other operating system, whether now known or later developed.

In addition, the present technology may employ any number of conventional techniques for data transmission, signaling, data processing, network control, and the like. Computing devices according to various aspects of the present technology may communicate with each other by one or more telecommunication networks. The telecommunication network may comprise a collection of terminal nodes, links, and any intermediate nodes which are connected to enable communication (including transfer of data) at a distance between the terminal nodes. In some embodiments, a terminal node may comprise a computing device. The telecommunication network may comprise any suitable communication system, such as the Internet, an intranet, an extranet, WAN, LAN, satellite communications, cellular radio network, wireless network, telephone network, cable network, and the like. Moreover, computing devices according to various aspects of the present technology may communicate over the telecommunication network using TCP/IP, HTTP, HTTPS, FTP, IPX, AppleTalk, IP-6, NetBIOS, OSI, and/or any number of existing or future protocols. The telecommunication network may be simply referred to as a network.

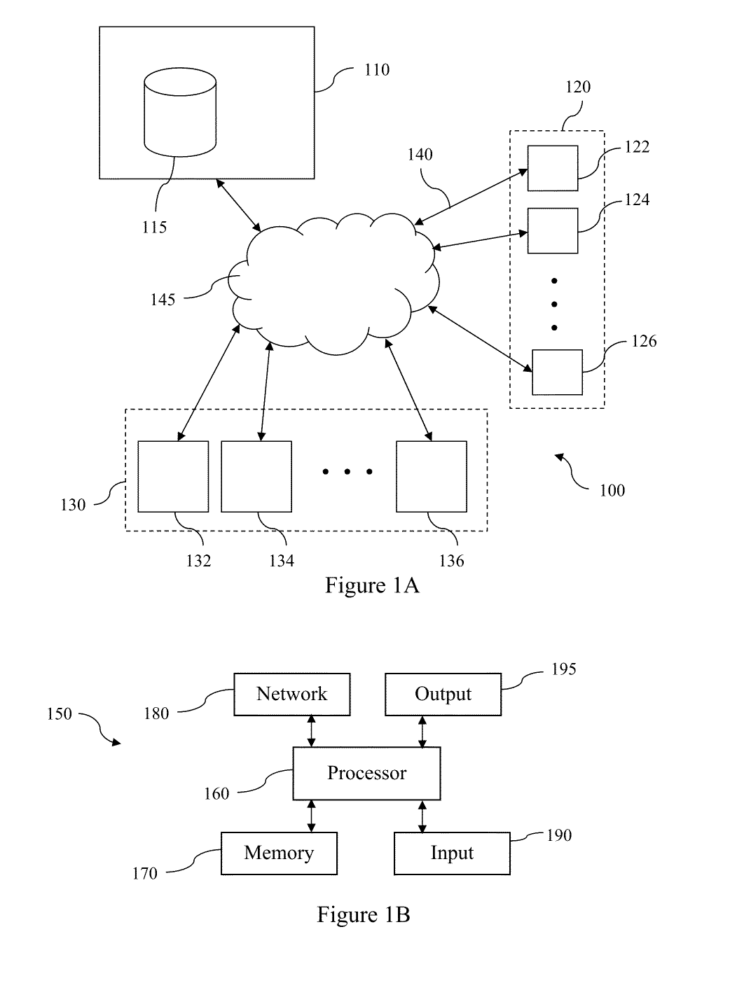

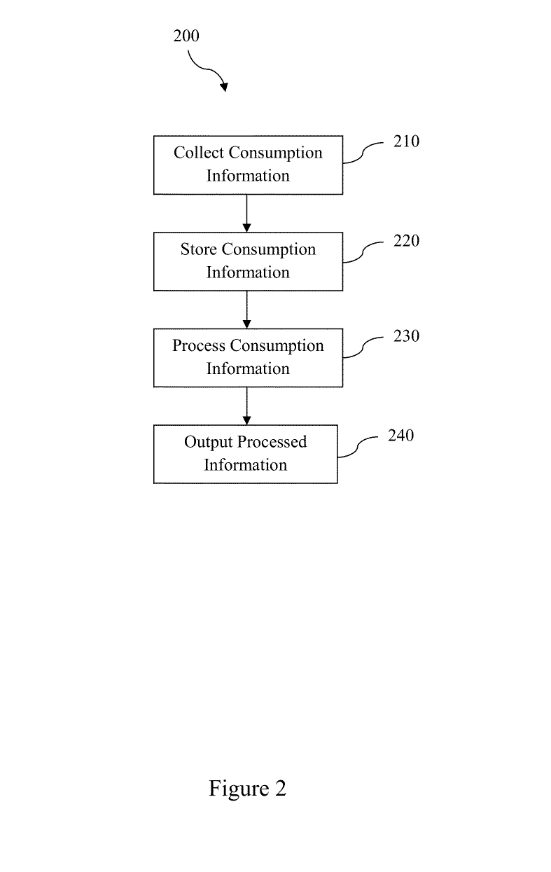

Referring to FIG. 1A, a utility monitoring system 100 according to various aspects of the present invention may operate in conjunction with one or more monitoring devices, computers, and output devices exchanging data to facilitate the understanding of utility and power consumption in a particular zone. A zone may comprise any physical and/or virtual region, area, grouping, and/or otherwise definable space, collection, assemblage, and the like. An exemplary utility monitoring system 100 comprises a server 110, one or more monitoring devices 122, 124, 126 (collectively referred to as “monitoring devices” 120), and/or one or more client devices 132, 134, 136 (collectively referred to as “client devices” 130) communicatively linked to each other via one or more networks. Data may be transferred or exchanged among the various monitoring devices 120, client devices 130, and/or server 110 via a communications medium 140 and a network 145. In some embodiments, the server 110 and one or more client devices 130 may be combined into a single device. In some embodiments, the server 110 and one or more monitoring devices 120 may be combined into a single device. As used herein, a computer system according to the present technology may comprise one or more client devices 130 and/or one or more servers 110 in combination, communicatively linked, or otherwise operating collectively to perform the methods of the present technology.

The communications medium 140 may comprise any suitable medium for transferring information. For example, the communications medium 140 may comprise a hard-wired and/or wireless communications system, and may operate in conjunction with communications protocols, such as the Internet, a LAN, a WAN, or other suitable electronic network.

The network 145 may comprise one or more devices configured to exchange information via the communications medium 140, such as two or more computers that communicate information with each other. Further, the network 145 may comprise any network of computers or devices using additional or alternative systems for communicating information. The server 110 may communicate via the network 145, for example in conjunction with one or more monitoring devices 120 and/or the client devices 130. Any appropriate system and device may be connected to the network 145, such as computers, servers, phones, utility and power monitoring devices, environmental monitoring devices, weather monitoring and forecasting systems, location determination systems, inter-personal communication systems, mapping systems, data sources, and the like.

The data communicated via the communications medium 140 and/or network 145 between the server 110, the monitoring devices 120, and the client devices 130 may comprise any suitable data capable of being communicated via the communications medium 140 and/or the network 145. For example, the data may comprise a series of bits, a string of characters, a single digital file, or a collection of files that may comprise documents, images, video files, utility consumption data, weather data, map data, utility rate data, location data, inter-personal communication, or other collections of digital information.

The server 110, the monitoring devices 120, and the client devices 130 may comprise any suitable systems for communicating via the network 145 and/or the communications medium 140. The various components of the utility monitoring system 100 may be individually or collectively configured to collect, process, store, and output utility consumption information. The client devices 130 and the server 110 may comprise any suitable computing device, for example a special-purpose computer, a general-purpose computer specifically programmed to implement or otherwise execute (whether alone or in combination with other one or more other computing devices) the systems and methods of the invention, and the like. Such a computing device may comprise a personal computer, server, mobile phone, smart phone, wearable computer, tablet computer, television, kiosk, and the like.

Referring now to FIG. 1B, the computing device 150 may comprise conventional components, such as any number of processors 160 communicatively coupled with any number of memory devices 170, any number of network adaptors 180, and any number of input 190 and/or output 195 devices such as a keyboard, mouse, monitor, touch-sensitive input device such as touch screen, touch sensor, and the like, microphone, speaker, motion sensor, orientation sensor, light sensor, and the like. A server 110 need not comprise an input device 190 and/or output device 195. The memory device 170 may comprise any combination of local memory such as RAM, long term memory such as a hard disk, and the like. The processor 160 may be configured to access (read and/or write) the memory device 170.

The memory device 170 may facilitate the storage of data and/or one or more computer instructions, such as a software routine and/or software program, which may be executable by the processor 160 to perform the methods of the invention. For example, the memory device 170 may store utility consumption information, weather information, utility rate information, map information, user information, and the like.

The processor 160 may be configured to provide the output device 195 with content to present and may be configured to receive input from the input device 190. In one embodiment, the input device 190 may be integrated into the output device 195, such as in a touch screen display. In one embodiment, the computing device 150 may comprise a network adaptor 180 that allows the processor 160 to communicate with another computing device 150. For example, the network adaptor 180 may comprise an Ethernet adaptor, a wireless networking adaptor, a radio networking adaptor, a USB networking adaptor, and the like.

Referring again to FIG. 1A, the monitoring devices 120 may comprise any suitable system for detecting and/or measuring a physical quantity and/or state, and transmitting corresponding information to another system. In an exemplary embodiment, the monitoring devices 120 may detect and/or collect information corresponding to utility consumption and may transmit the same or related information via the network 145 and/or the communications medium 140. Utility consumption may comprise the use of one or more utilities and/or power sources. For example, utility consumption may comprise the use of water, electricity, natural and/or other gas, and may comprise the use of other sources for providing heating, cooling, electricity, water, lighting, and the like to a building or structure. Further, utility consumption may comprise the use of gasoline and/or other energy sources used to power equipment, such as lawn mowers, backup generators, vehicles, or other transportation. The information detected, collected, and/or measured by the monitoring devices 120 may be referred to as utility consumption information.

Additionally, utility consumption may comprise the generation of one or more utilities, energy, and/or power. For example, a building may generate electricity through the use of solar panels. Information corresponding to the generated electricity may be appropriately measured and transmitted by one or more monitoring devices 120, and may be referred to as utility consumption information.

In some embodiments, a monitoring device 120 may comprise a sensor configured to detect and/or measure one or more environmental conditions. An environmental condition may comprise any state of the environment a monitoring device is configured to operate in or observe. As used in this application, utility consumption may comprise the detected and/or measured environmental conditions. Accordingly, the output of such monitoring devices 120 may be referred to as utility consumption information.

An environmental condition may comprise the presence, absence, and/or amount of a substance or condition. For example, an environmental condition may comprise the presence, absence, or increase of a hazardous substance or condition. Furthering the example, an environmental condition may comprise the presence of harmful radiation, and one or more monitoring devices 120 may be configured to detect the presence of the radiation, measure an amount of the radiation, and/or measure or detect if the amount of radiation is unacceptable. As an additional example, an environmental condition may comprise the presence of carbon dioxide (CO₂), and one or more monitoring devices 120 may be configured to measure the amount of CO₂ present. An environmental condition may comprise the presence, absence, or reduction of a beneficial substance or condition. For example, an environmental condition may comprise a reduction in breathable oxygen (O₂), and one or more monitoring devices 120 may be configured to detect if the level of O₂ present can negatively affect humans, or may be configured to measure the amount of O₂ present. An environmental condition may comprise a ratio of substances. For example, one or more monitoring devices 120 may be configured to measure the ratio of CO₂ to O₂.

In addition, an environmental condition may comprise the presence or absence of a substance caused by other utility consumption. For example, combustion of natural gas consumes O₂ and produces CO₂ and water, and one or more monitoring devices 120 may be configured to measure O₂, CO₂, and/or water. For further example, the one or more monitoring devices 120 may be configured to only measure the environmental conditions caused by other utility consumption, such as measuring only the O₂, CO₂, and/or water consumed and produced by the combustion of natural gas.

An environmental condition may comprise any other measurable quantity and/or detectable state relating to the environment one or more monitoring devices 120 are configured to operate in or observe. For example, an environmental condition may comprise the temperature, status of air conditioning or heating, air circulation, light level, sound level, and the like. In addition, environmental conditions may not be limited to those relevant to humans or other forms of life, and may comprise conditions affecting machines, equipment, materials, and the like. In addition, the monitoring devices 120 may be configured to measure and/or detect an environmental condition of water, air, earth, and/or space.

In some embodiments, the monitoring device 120 may comprise an electricity meter, a gas meter, a water meter, a smoke detector, a carbon monoxide detector, or a CO₂ meter. The monitoring device 120 may collect information about the consumption of only one utility type, such as electricity, or may collect information about the consumption of more than one utility type. The monitoring devices 122, 124, 126 may each collect information about the same type of utility, or may each collect information about different types of utilities. For example, all monitoring devices 120 may collect information about electricity usage, or some monitoring devices 120 may collect information about electricity usage while other monitoring devices 120 collect information about water usage.

In some embodiments, the monitoring device 120 may collect information about one environmental condition, such as CO₂, or may collect information about more than one environmental condition. The monitoring devices 122, 124, 126 may each collect information about the same environmental condition, or may each collect information about different environmental conditions. For example, all monitoring devices 120 may collect information about arsenic in water, or some monitoring devices 120 may collect information about arsenic in water while other monitoring devices 120 collect information about CO₂ in the air.

The monitoring devices 120 may be configured to transmit the utility consumption information via the network 145 and/or communications medium 140, or may be configured to process or manipulate the utility consumption information before transmitting the utility consumption information via the network 145 and/or communications medium 145. The utility monitoring system 100 may be configured to operate in conjunction with any number and type of monitoring devices 120.

The server 110 may comprise any appropriate system for receiving, storing, and transmitting utility consumption information via the network 145, such as a computer server or a computerized database. In an exemplary embodiment, the server 110 comprises a long-term storage device 115, such as the memory device 170. A database system may be implemented using the long-term storage device 115, may be configured to store information about states, cities, buildings, floors, tenant space, and various other zones about which the monitoring devices 120 are collecting utility consumption information, and may be configured to store utility consumption information. In one embodiment, one or more client devices 130 may comprise a long-term storage device 115, such as the memory device 170. In yet another embodiment, the long-term storage device 115 may be separate from but communicatively linked with the client devices 130 and/or server 110, such as in a data center.

In an exemplary embodiment, the server 110 is configured to receive information from one or more of the monitoring devices 120. The received information may comprise utility consumption information. The received information may also comprise information facilitating the association of the utility consumption information with a particular zone, such as a country, state, city, building, floor, office, tenant space, or any other region. For example, the received information may comprise identifying information that allows the server to determine which zone a particular set of utility consumption information was collected from. In an exemplary embodiment, the monitoring devices 120 are configured to generate and/or transmit the identifying information. In an exemplary embodiment, the identifying information comprises a unique identification assigned to a specific monitoring device 122, 124, 126, such as a serial number or IP address, and the server 110 and/or database 115 may be configured to associate the unique identification with a particular location being monitored. The server 110 may be configured to transmit any information received from the monitoring devices 120, and/or any information generated by the server 110 based on the received information, to one or more client devices 130.

The server 110 may be configured to access weather information, including historical and current weather information and weather forecasts. The server 110 may be configured to associate the weather information with a particular zone being monitored by one or more monitoring devices 120. The server 110 may be configured to access map information, such as street maps or satellite images, and may be configured to associate the map information with a particular zone being monitored by one or more monitoring devices 120. The server 110 may be configured to associate the weather information with the map information. The server 110 may be configured to access historical and current utility rate (or cost) information. In some embodiments, the server 110 may be configured to store the weather information, map information, utility rate information, or any combination thereof, and may associate such information with a one or more zones being monitored by the monitoring devices 120.

The server 110 may be configured to perform any suitable analysis of the utility consumption information in comparison to the map information, weather information, utility rate information, or any combination thereof. In an exemplary embodiment, the server 110 is configured to generate data corresponding to present and past utility consumption, and may be configured to adjust or normalize the generated data based on any relevant factor, such as number of building occupants, weather information, utility rates, and the like. For example, the server 110 may be configured to normalize the information corresponding to past utility consumption based on the historical weather data. This, for example, facilitates the analysis of utility consumption taking into consideration the effects of past weather conditions, and allows for an alternative measurement of utility consumption. In an exemplary embodiment, the server 110 may be configured to compare the cost of past utility consumption to current utility consumption based on the past and current utility consumption information and the historical and current utility rate information. In an exemplary embodiment, the server 110 may be configured to determine past and current utility consumption costs for various zones, for example in conjunction with the map information.

The server 110 may be configured to determine a change in the utility consumption for one or more zones based on the received and/or stored utility consumption information, determine a cost savings or loss associated with the change in utility consumption, and determine a capital valuation and/or a change in capital valuation of one or more structures being monitored due to the cost savings or loss. The server 110 may be configured to determine a capitalization rate for one or more of the structures. For example, the server 110 may be configured to determine the reduction in utility consumption for a particular building for the past week, month, year, or any other time period, and may comprise determining a cost savings associated with the reduction in utility consumption. The server 110 may be further configured to determine a capitalization rate for the building, and determine the increase in the building's capital valuation based on the cost savings and capitalization rate.

For example, the server 110 may be configured to evaluate the capitalization rate of a structure using the formula:

Capitalization Rate=Operating Income/Structure Cost (or Value)

The server 110 may be configured to evaluate the capital valuation of a structure using the formula:

Capital Valuation=Operating Income/Capitalization Rate

The server 110 may additionally or alternatively be configured to evaluate the change in capital valuation of a structure using the formula:

Capital Valuation Change=Operating Income Change/Capitalization Rate

In some embodiments, the client devices 130 may be configured to perform some or all of the above determinations, evaluations, and calculations corresponding to capitalization rates, capital valuations, and changes in capital valuation.

The server 110 may comprise a system or software to manage users of the utility monitoring system 100. For example, the server 110 may provide a portal for a user to log in to the server 110 and/or the utility monitoring system 100. The server 110 may provide different levels of access for different users. The server 110 may store the name, location, position, and other information relating to one or more users. The server 110 may allow one or more users to configure the server 110 and/or the various components of the utility monitoring system 100. For example, the server 110 may allow a user to configure certain views or information feeds displayed on one or more of the client devices 130 as “favorites,” which then may be easier or quicker to access by that particular user. The server 110 may allow an administrative user to configure and perform maintenance operations on the various components of the utility monitoring system 100.

The client devices 130 may comprise any suitable system for outputting the information transmitted by the server and capable of communicating via the network 145 and/or communications medium 140. For example, a client may comprise one or more software applications executing on a computerized device, or may comprise a tablet or other computer, a kiosk, terminal, television, mobile device, any display and/or audio device, and the like.

One or more client devices 130 may comprise a display device coupled to the network 145 and/or communications medium 140, and may be located at or near the location or zone being monitored. In an exemplary embodiment, the client devices 130 may comprise a device located on a particular floor of a building and configured to receive processed or unprocessed utility consumption information corresponding to the floor from the server 110 and/or one or more monitoring devices 120 collecting utility consumption information relating to the floor, and configured to output the received information on a display of the device. In an exemplary embodiment, the client devices 130 may be configured to receive and display processed or unprocessed utility consumption information at any level of granularity available in the utility monitoring system 100. For example, the client devices 130 may receive and display utility consumption information corresponding to a particular zone, such as a room, floor quadrant, floor, tenant space, building, block, city, state, country, or any other region.

One or more client devices 130 may comprise a software application executable on a computerized device capable of accepting user input. In some embodiments, the client devices 130 may be configured to accept user input to affect the display of information, manipulate data, configure the various components of the utility monitoring system 100, send electronic messages, and the like. In an exemplary embodiment, the client devices 130 may comprise a standard web browser running on a tablet computer, smart phone, or other computer system, which is executing and/or displaying a web page generated by the utility monitoring system 100. In an exemplary embodiment, the client devices 130 may comprise a software application stored on a computerized device that when executed, configures the device to receive utility consumption information from the server 110 and/or the monitoring devices 120, and configures the device to output the utility consumption information to a user of the device. In some embodiments, the client devices 130 may be configured to process the utility consumption information before causing it to be outputted by the device.

In some embodiments, one or more client devices 130 may receive utility consumption information directly from the monitoring devices 120, such as to display real-time utility consumption information. The utility consumption information may also be routed through the server 110 with or without being stored at the server 110. The client devices 130 may be configured to store the utility consumption information. In some embodiments, the client devices 130 may be configured to receive and/or store weather, map, and utility rate information, and may be configured to perform processing and manipulation of the utility consumption information in a similar manner to the server 110.

The server 110 and/or the client devices 130 may be configured to generate statistics corresponding to utility consumption based on the utility consumption information received from the monitoring devices 120. The responsibility for generating the statistics may be divided up in any manner among the server 110 and the client devices 130. In one exemplary embodiment, the server 110 may be configured to perform all generation of utility consumption statistics and any other related information, and the client devices 130 may be configured to simply receive and display the information received from the server 110. In another exemplary embodiment, the server 110 may be configured to simply receive and store the utility consumption information from the monitoring devices 120, and the client devices 130 may be configured to receive the utility consumption data from the server 110 and may perform all generation of the utility consumption statistics and any other related information. In a third exemplary embodiment, both the server 110 and one or more client devices 130 may be configured to generate some or all of the statistics and other related information.

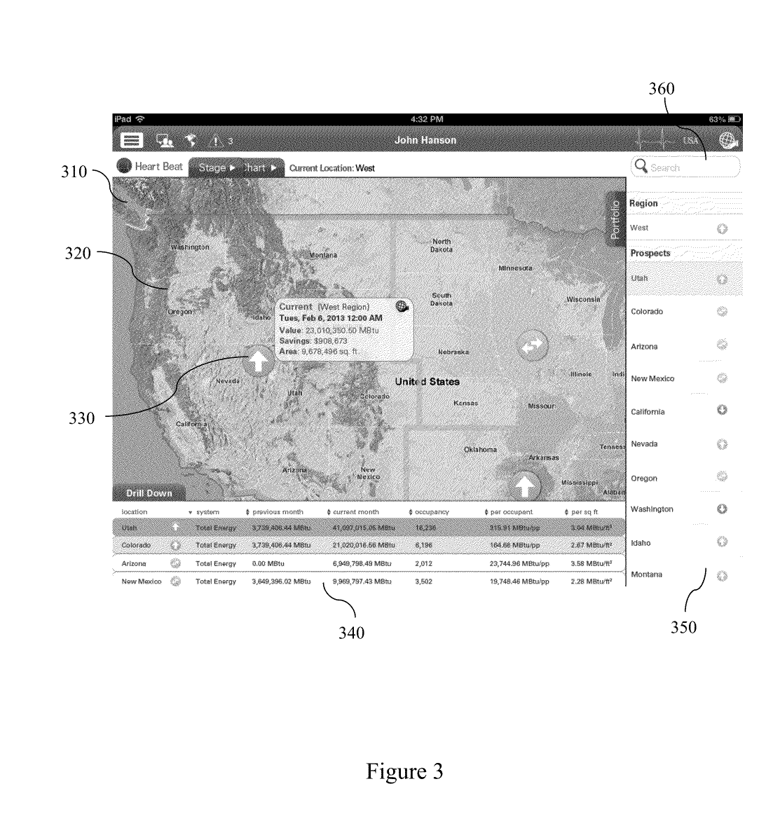

Referring now to FIG. 2, a utility monitoring method (200) according to various aspects of the present invention may comprise any method for collecting and analyzing utility consumption information, and outputting the analysis results to a user. For example, a utility monitoring method (200) may comprise collecting utility consumption information (210), storing the collected utility consumption information (220), processing the utility consumption information (230), and outputting the processed utility consumption information (240).

Collecting utility consumption information (210) may comprise any suitable system or method for measuring, detecting, or otherwise sensing utility consumption and generating information corresponding to the utility consumption. Collecting utility consumption information (210) may also comprise transmitting the utility consumption information via the network 145 and/or communications medium 140, such as to the server 110 and/or one or more client devices 130. In an exemplary embodiment, collecting utility consumption information (210) may comprise measuring utility consumption by one or more monitoring devices 120. For example, collecting utility consumption information (210) may comprise measuring the use of electricity, natural gas, and/or water using one or more electricity, natural gas, and/or water meters. Collecting utility consumption information (210) may also comprise detecting and/or measuring environmental conditions or measuring power generation, for example through the use of one or more monitoring devices 120. The collected utility consumption information may be sent via the network 145 and/or communications medium 140 to the server 110 and/or one or more client devices 130.

In addition, the utility consumption information may be sent or routed through an intermediary device before being sent to the server 110 and/or one or more client devices 130. Such an intermediary device may comprise a system for collecting and/or aggregating the detected information from one or more monitoring devices 120 and then transmitting the information via the network 145 and/or communications medium 140. The intermediary device may manipulate the information such that the server 110 and/or client devices 130 can identify which individual monitoring device 122, 124, 126 or group of monitoring devices 120 the detected information originated from.

Storing the collected utility consumption information (220) may comprise any suitable system or method for saving the collected utility consumption information such that it is usable at a later time. In an exemplary embodiment, storing the collected utility consumption information (220) may comprise saving the utility consumption information transmitted by the monitoring devices 120 to a long-term storage device 115 of the server 110. For example, the long-term storage device 115 may implement a computer database, in which the transmitted utility consumption information is stored. In some embodiments, storing the collected utility consumption information (220) may comprise manipulating or organizing the information before saving the information. For example, the utility consumption information may comprise information about which zone, location, or monitor the information was generated by, and storing the collected utility information (220) may comprise saving both the location information and the utility consumption information in a manner such that the various types of information are associated with each other. The collected utility consumption information may be stored (220) at the server 110, one or more of the client devices 130, or any combination thereof.

Processing the utility consumption information (230) may comprise any suitable system or method for converting the collected utility consumption information into a form suitable for use or comprehension by a human or other system. Processing the utility consumption information (230) may be performed by the server 110 (as described in detail above), one or more client devices 130, or any combination thereof.

In an exemplary embodiment, processing the utility consumption information (230) may comprise calculating or retrieving data corresponding to past utility consumption, calculating or retrieving data corresponding to current utility consumption, and generating a comparison of both sets of data. For example, the comparison may comprise a table, chart, graph, and the like, comprising both sets of data. The comparison may be suitably configured for output to a display. In some embodiments, processing the utility consumption information (230) may comprise generating a comparison of past utility consumption to current utility consumption for one or more zones, including both usage and/or cost. In some embodiments, the comparison between past and current utility consumption may comprise any relevant trend, such as a trend indicating whether utility consumption for a zone is increasing or decreasing, getting better or worse, or remaining stable. In some embodiments, processing the utility consumption information (230) may comprise comparing utility consumption information for individual utilities, power sources, and other measured quantities, comparing total energy and utility consumption, or any combination thereof. In some embodiments, processing the utility consumption information (230) may comprise comparing utility consumption information for individual environmental conditions, comparing utility consumption information for environmental conditions corresponding to the air, water, earth, and/or space, comparing totals of environmental conditions, or any combination thereof.

In an exemplary embodiment, processing utility consumption information (230) may comprise generating statistics corresponding to historical, current, and predicted future utility consumption. The statistics may correspond to any granularity of zones, such as individual zones, groups of zones, or the entire collection of zones. The statistics may be generated by the server 110 and/or one or more client devices 130. The statistics may be generated when each new piece of utility consumption information is received by the server 110 or client devices 130, may be generated at regular intervals, or may be generated on demand, such as when a user or another system requests the statistics. The statistics may be generated based on a moving average, a regression, and the like. The statistics may be generated when a new piece of information relevant to utility consumption is received by the server 110 or client devices 130, such as an updated weather conditions or an updated occupant count.

In some embodiments, generating the statistics may comprise accessing information relating to past, present, future, and predicted utility rate information, weather information, map information, and/or location information. In some embodiments, generating the statistics may comprise determining the utility cost per occupant or per square foot, determining utility cost savings, determining carbon output saved or produced, and the like. In some embodiments, generating the statistics may comprise normalizing the utility usage or cost based on any relevant factor, such as number of occupants, weather information, square footage, utility rate, and the like.

In some embodiments, processing utility consumption information (230) may comprise retrieving the stored utility consumption information and organizing or reorganizing the utility consumption information. For example, utility consumption information may be stored according to the monitoring devices 120 that generated the utility consumption information, and processing the utility consumption information (230) may comprise organizing the utility consumption information according to the zone the utility consumption information originated from.

In some embodiments, the organized utility consumption information may be reorganized according to user input. For example, utility consumption information may initially be displayed to a user based on the zone they are located in, based on preconfigured user settings, based on user selection, or the like. A user may pick a lower-level zone to view more local utility consumption information, or may pick a higher-level zone to view broader utility consumption information. Processing utility consumption information (230) would then comprise organizing utility consumption information according to the initially selected zone, and then reorganizing the utility consumption information according to the higher- or lower-level zone once it is selected. The systems and methods of the present invention may facilitate a user drilling down or viewing utility consumption for any zone or level of granularity available to the utility monitoring system 100.

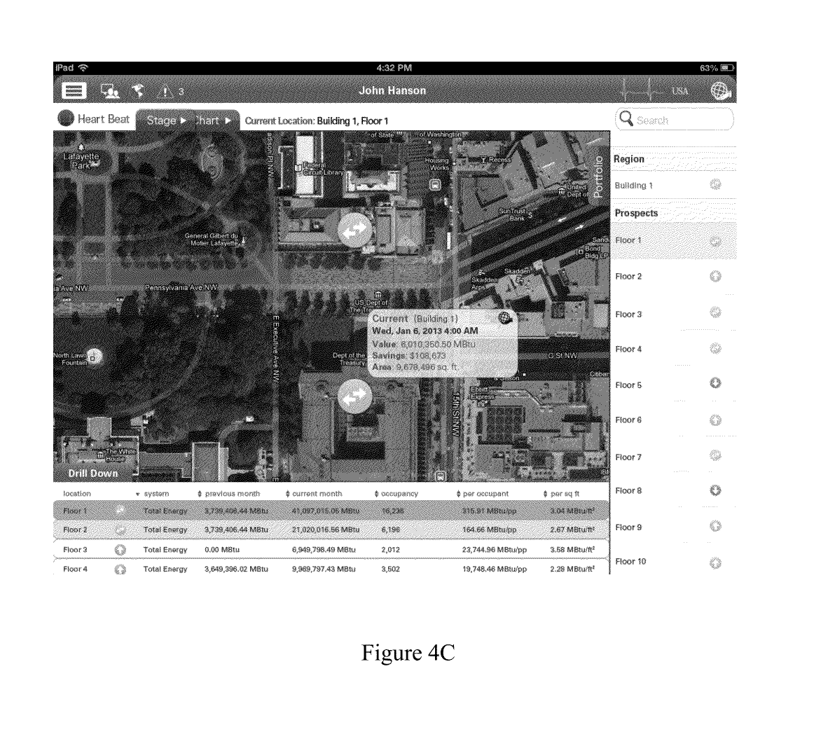

For example, referring to FIGS. 4A-4C, a user may start with the zone “Mid Atlantic” which will cause the systems and methods of the present invention to organize and present utility consumption information based on the “Mid Atlantic” zone. The user may then select the sub-zone “Washington DC” which will cause the systems and methods of the present invention to organize and present utility consumption information based on the “Washington DC” zone. The user may select a further sub-zone of “Building 1” located in the “Washington DC zone”, which will cause the systems and methods of the present invention to organize and present utility consumption information based on the “Building 1” zone.

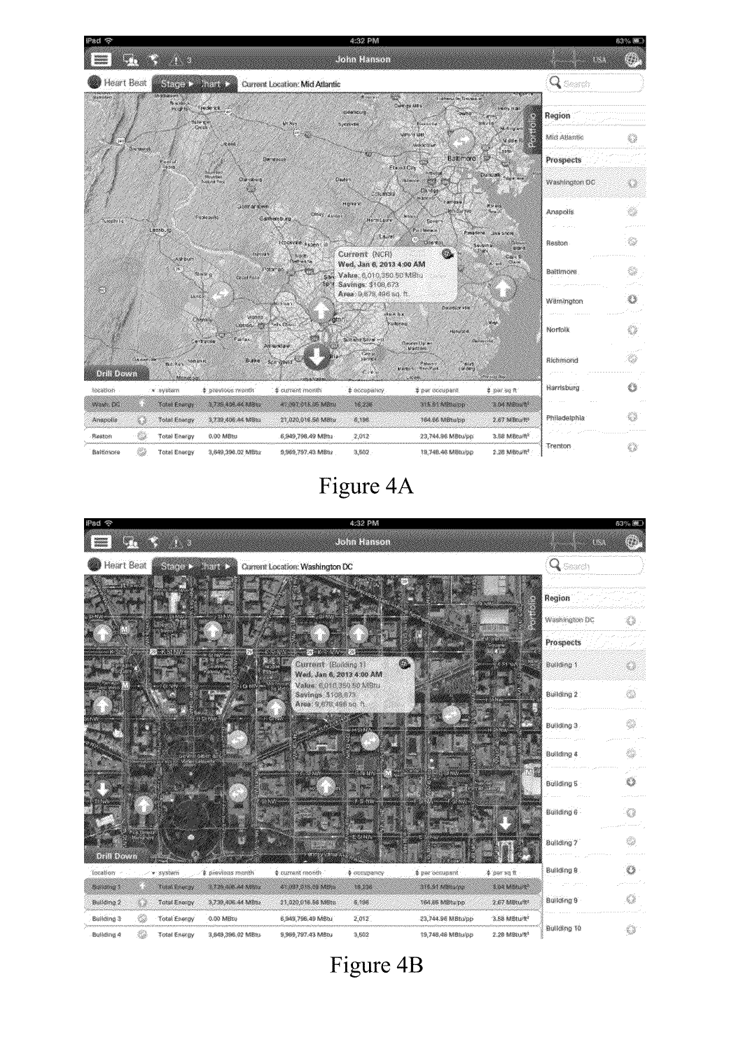

In some embodiments, the systems and methods of the present invention may provide the capability to search any information stored in the utility monitoring system 100. For example, referring to FIG. 3, a user may be able to initiate a search using a search interface 360 of a client device 132, 134, 136, where the search may comprise the name of a zone being monitored by one or more monitoring devices 130, such as the name of a building, city, state, or region being monitored, and the like. The search may result in the display of information corresponding to the search term, such as utility consumption information for a searched building. In some embodiments, a zone may be selected from a list, such as the list of zones 350 shown in FIG. 3.

In various embodiments, processing utility consumption information (230) may comprise arranging, organizing, calculating, or any other manipulation of the utility consumption information, based on user input. The user input may comprise settings configured by a user, or may comprise real-time input by the user. In some embodiments, processing utility consumption information may comprise combining and/or analyzing information about past, present, and predicted utility consumption with map information, weather information or forecasts, utility rate information, or information corresponding to the location of a user. In some embodiments, processing utility consumption information (230) may be performed based on information pertaining to the location of a user, such as information obtained via a GPS receiver.

In an exemplary embodiment, processing utility consumption information (230) may comprise determining if any locations (e.g. zones) being observed by the monitoring devices 120 are experiencing unusual conditions. For example, processing utility consumption information (230) may comprise tracking the electrical consumption of a building and determining whether the building is experiencing abnormal conditions such as a blackout, brownout, or other power fluctuation or power loss.

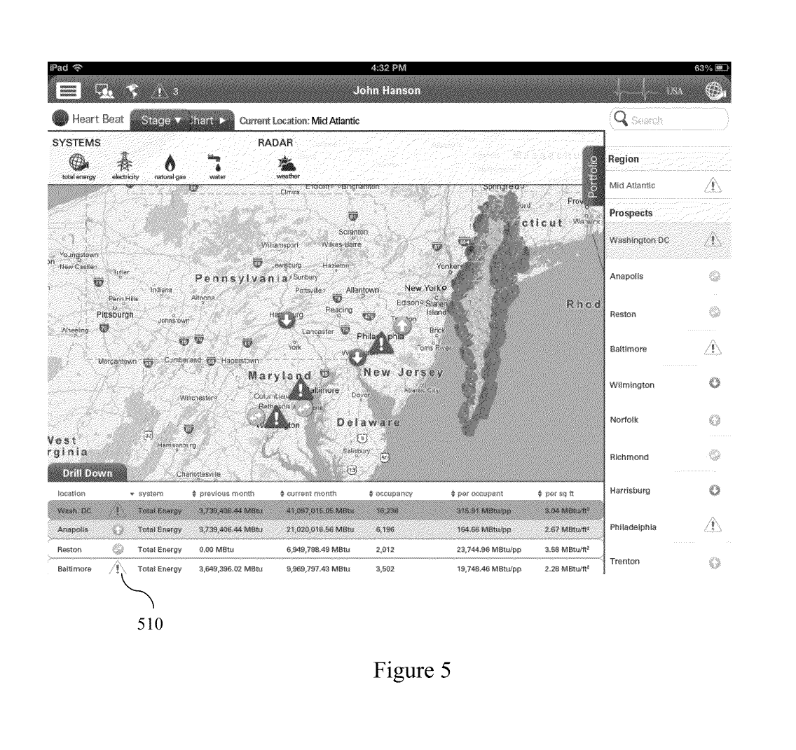

Referring to FIG. 5, in some embodiments, processing utility consumption information (230) may comprise combining weather information, utility consumption information, and map information. In some embodiments, processing utility consumption information (230) may comprise predicting future utility consumption based on weather forecast information. For example, processing utility consumption information (230) may comprise predicting future utility consumption for a particular zone based on information about current and/or historical weather conditions and current and/or historical utility consumption information in and/or near the particular zone, and weather forecast information in and/or near the particular zone.

In some embodiments, processing utility consumption information (230) may comprise determining a change in the utility consumption for one or more zones, determining a cost savings or loss (e.g. a change in cost) associated with the change in utility consumption, and determining a capital valuation and/or a change in capital valuation of one or more structures being monitored due to the cost savings or loss. Processing utility consumption information (230) may comprise determining a capitalization rate for one or more of the structures. For example, processing utility consumption information (230) may comprise determining the reduction in utility consumption for a particular building for the past week, month, year, or any other time period, and may comprise determining a cost savings associated with the reduction in utility consumption. Processing utility consumption information (230) may also comprise determining a capitalization rate for the building, and determining the increase in the building's capital valuation based on the cost savings. In some embodiments, determining a capitalization rate, a capital valuation, or a change in capital valuation may use the appropriate formulas previously discussed.

For example, processing utility consumption information (230) may comprise determining that a particular building experienced an 8% reduction in utility consumption for a particular period. Processing utility consumption information (230) may further comprise determining that the cost saving associated with the reduction in utility consumption is $76,032. In some embodiments, determining the cost savings may comprise the use of past or present utility rate information. Processing utility consumption information (230) may comprise determining that the Capitalization Rate is 9% for the building, and determining that the Capital Valuation Change for the building is equal to $76,032/9%, or $844,800.

Outputting the processed utility consumption information (240) may comprise any suitable system or method for making the processed utility consumption information observable by a person or another system. Outputting the processed utility consumption information (240) may comprise the server 110 working in conjunction with one or more client devices 130 to cause the processed utility consumption information to be presented. For example, the server 110 may transmit the processed utility consumption information (240) to one or more client devices 130, and the one or more client devices 130 may display the received processed utility consumption information.

In an exemplary embodiment, outputting the processed utility consumption information (240) comprises causing a table containing a comparison of utility consumption information to be presented on one or more client devices 130. In an exemplary embodiment, outputting the processed utility consumption information (240) comprises causing a list of zones and corresponding trend information to be displayed on one or more client devices 130. In an exemplary embodiment, outputting the processed utility consumption information (240) comprises causing the processed utility consumption information (240) to be displayed in conjunction with a map on one or more client devices 130. In some embodiments, outputting the processed utility consumption information (240) may comprise alerting a person of an unusual condition measured by one or more monitoring devices 130 or otherwise determined (230), such as by displaying an alert, playing an audible alert, sending a suitable electronic message to a user, and the like.

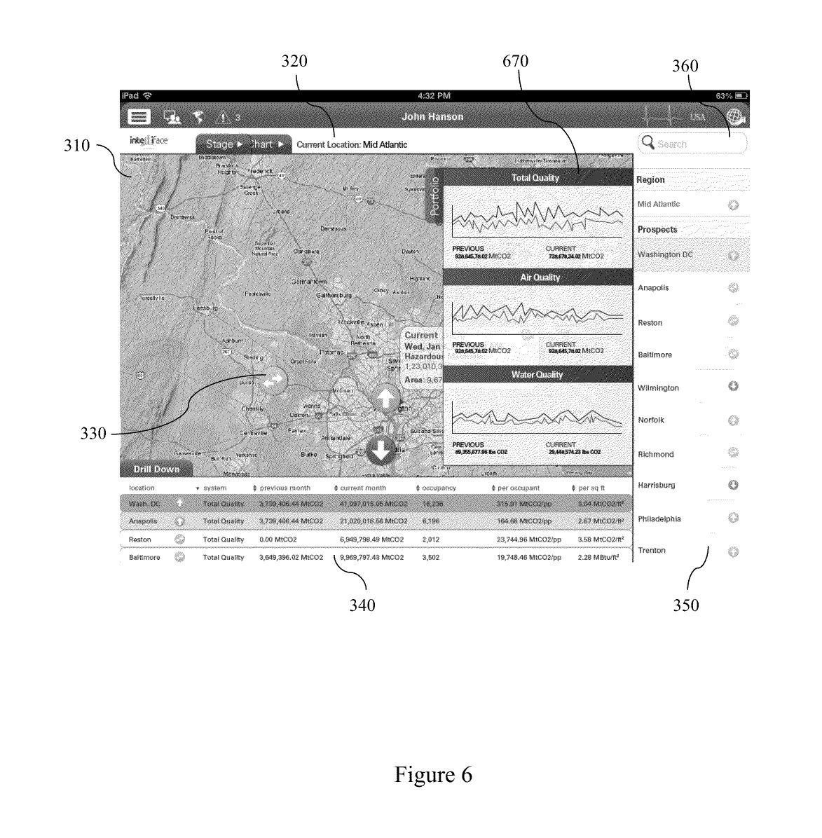

For example, referring to FIG. 3, processing utility consumption information (230) and outputting the processed utility consumption information (240) may comprise generating and displaying the processed utility consumption information in conjunction with a map 310, a table 340, and/or a list 350 on one or more client devices 130. Referring briefly to FIG. 6, processing utility consumption information (230) and outputting the processed utility consumption information (240) may comprise generating and displaying the processed utility consumption information in conjunction with one or more graphs 670. The processed utility consumption information may comprise statistics related to the utility consumption, such as utility consumption for the previous month, current month, per occupant, and per square foot. The processed utility consumption information may also comprise occupancy, square footage, savings associated with the utility consumption, and a value of the utility consumption and/or savings. The processed utility consumption information may also comprise an indication of the utility consumption trend 330 for the relevant zone 320. Referring to FIG. 5, the processed utility consumption information may also comprise an indication of an unusual condition 510 for the relevant zone. The unusual condition may comprise an alert condition. An alert condition or a trigger for an indication may be predetermined.

Referring again to FIG. 3, the list 350 and the table 340 may correspond to sub-zones of the zone 320 being observed on the map 310. For example, the processed utility consumption information displayed in conjunction with the map may correspond to the zone “West” observed on the map 310, and the processed utility consumption information displayed in conjunction with the table 340 and list 350 may correspond to sub-zones of the “West” zone observed on the map, such as states within the “West” zone.

In an exemplary embodiment, outputting the processed information (240) may comprise sending the processed information to a communication system configured to deliver the processed information to a person. For example, outputting the processed information (240) may comprise creating and/or sending an electronic message, such as a text or email, containing the processed information to a specified person.

Outputting the processed information (240) may be performed differently for different types of users, based on the zone being observed by a user, and/or based on the zone where the user is currently located in. The type of user may comprise a technician working at a facility, a director of a facility, an energy management director for a company owning one or more facilities, and the like. For example, a technician at a facility being monitored by the monitoring devices 120 may receive the most detailed utility consumption information about the facility and no information about the utility consumption information of other facilities; a director of a facility may receive somewhat detailed information about the utility consumption of the facility and somewhat detailed information about other facilities in the same city, and an energy management director may receive all information about utility consumption in all facilities being monitored by the monitoring devices 120. For further example, unusual conditions detected or forecasted may cause alerts to be generated. The type of alerts may be varied based on the type of user the alert is being sent to, based on where the user is located, and/or based on the zone being observed by the user. In this exemplary embodiment, outputting the processed information (240) may comprise deciding not to send alerts or other information to one or more users.

In some embodiments, the present invention may comprise communication systems and methods that facilitate the interaction of various users of the utility monitoring system 100. For example, the systems and methods of the present invention may allow one user to send an email to another user, where the email may pertain to utility consumption. As another example, the systems and methods of the present invention may facilitate the sharing of documents. For further example, the systems and methods of the present invention may facilitate long-term storage of user knowledge, such as by use of a knowledge base. In some embodiments, the knowledge base may be implemented as a compilation of notes and messages created by one or more users. As another example, the systems and methods of the present invention may provide real-time video or chat capability. In some embodiments, the utility monitoring system 100 may be configured to access communication and contact information of an existing communication system. For example, the utility monitoring system 100 may be configured to access contact information from a proprietary or standard email system.

In the foregoing description, the invention has been described with reference to specific exemplary embodiments. Various modifications and changes may be made, however, without departing from the scope of the present invention as set forth. The description and figures are to be regarded in an illustrative manner, rather than a restrictive one and all such modifications are intended to be included within the scope of the present invention. Accordingly, the scope of the invention should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present invention and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

For the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

1. A computer-implemented method for analyzing utility consumption, comprising:
collecting, by a monitoring device, utility consumption information;
storing, by the computer, the utility consumption information to a storage device;
processing, by the computer, the utility consumption information; and
outputting, by the computer, the processed utility consumption information.

2. A computer-implemented method according to claim 1, wherein processing the utility consumption information comprises normalizing the utility consumption information.

3. A computer-implemented method according to claim 1, wherein processing the utility consumption information comprises generating a comparison of historical utility consumption information to current utility consumption information.

4. A computer-implemented method according to claim 3, wherein processing the utility consumption information comprises determining a trend.

5. A computer-implemented method according to claim 1, wherein processing the utility consumption information comprises determining if a zone being monitored by the monitoring device experiences an unusual condition.

6. A computer-implemented method according to claim 1, wherein processing the utility consumption information comprises predicting future utility consumption.

7. A computer-implemented method according to claim 6, wherein the predicted future utility consumption is based on a weather forecast.

8. A computer-implemented method according to claim 1, wherein outputting the processed utility consumption information comprises presenting the processed utility consumption information in conjunction with a map, wherein the map and the processed utility consumption information correspond to a particular zone.

9. A computer-implemented method according to claim 1, wherein the utility consumption information comprises a time series data point, and storing the utility consumption information to a storage device comprises:
transforming the time series data point according to a configuration definition; and
storing the transformed time series data point to an analytical database.

10. A computer system for analyzing utility consumption, configured to:
receive, from a monitoring device, utility consumption information;
store the utility consumption information to a storage device;
process the utility consumption information; and
output the processed utility consumption information.

11. A non-transitory computer-readable medium storing computer-executable instructions for analyzing utility consumption, wherein the instructions are configured to cause a computer system to:
receive, from a monitoring device, utility consumption information;
store the utility consumption information to a storage device;
process the utility consumption information; and
output the processed utility consumption information.
